(19) United States
(12) Patent Application Publication
(10) Pub. No.: US 2025/0094513 A1
(43) Pub. Date: Mar. 20, 2025

(54) DYNAMICALLY OPTIMIZED RECOMMENDATIONS IN GENERATIVE MEDIA

(71) Applicant: Promoted.ai, Inc., San Francisco, CA (US)

(72) Inventor: Andrew Donald Yates, San Francisco, CA (US)

(21) Appl. No.: 18/823,463

(22) Filed: Sep. 3, 2024

Related U.S. Application Data
(60) Provisional application No. 63/538,906, filed on Sep. 18, 2023.

(51) Int. Cl. G06F 16/9535; G06F 16/2457; G06F 16/9538

(52) U.S. Cl. CPC G06F 16/9535; G06F 16/24578; G06F 16/9538

(57) ABSTRACT

Methods and systems provide for dynamically optimized recommendations in generative media. In one embodiment, the system receives, through a conversational interface, input submissions from a user engaging in a conversation with a generative artificial intelligence (AI) system; generates, via the generative AI system, a search query for a search engine backend of the platform; sends the search query to the search engine backend of the platform to retrieve at least a subset of a prompt as input to the generative AI system, the subset of the prompt including a sorted list of search results from the search engine backend; processes the prompt to generate a set of personalized recommendations for the user; and presents, within the platform presented at the client device, the set of personalized recommendations for the user, the presentation incorporating media content representing at least a portion of the search result items.

### CROSS-REFERENCE TO RELATED APPLICATIONS

This application claims the benefit of priority to U.S. Provisional Application No. 63/538,906, filed on Sep. 18, 2024, which is hereby incorporated by reference in its entirety.

### FIELD OF INVENTION

Various embodiments relate generally to content generation, and more particularly, to systems and methods for providing dynamically optimized recommendations in generative media.

### SUMMARY

The appended claims may serve as a summary of this application.

### BRIEF DESCRIPTION OF THE DRAWINGS

The present invention relates generally to content generation, and more particularly, to systems and methods providing for dynamically optimized recommendations in generative media.

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2 is a flow chart illustrating an exemplary method that may be performed in some embodiments.

FIG. 3A is a diagram illustrating one example embodiment of a user interface screenshot which presents one use case for facilitating recommendations for outdoor accommodation discovery and booking, in accordance with some embodiments.

FIG. 3B is a diagram illustrating one example embodiment of a user interface screenshot which presents search results and a conversational user interface with a generative AI chatbot, in accordance with some embodiments.

FIG. 3C is a diagram illustrating one example embodiment of a user interface screenshot which presents a user interacting with a generative AI chatbot within a conversational interface, in accordance with some embodiments.

FIG. 3D is a diagram illustrating one example embodiment of a user interface screenshot which presents a response from a generative AI system to a user's personalized needs and requests within a conversational interface, in accordance with some embodiments.

FIG. 4 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

The vast amount of information available on the internet has led to a reliance on search engines and recommendation systems to help users discover relevant content. Users often engage with conversational interfaces and platforms to seek information, make decisions, and access various services. These conversational interfaces have evolved from simple text-based interactions to sophisticated systems that incorporate natural language understanding and generative artificial intelligence (AI).

Conventional search engines have long been the primary tools for information retrieval on the internet. These engines operate based on keyword queries and provide users with lists of search results ranked by relevance to the query. While this approach has proven effective for a wide range of tasks, it has its limitations. Keyword-based search often requires users to distill complex information needs into a few words, which may not adequately capture their true intent. Additionally, search results are typically static and lack context, making it challenging for users to navigate through extensive lists of results to find the most relevant information.

Recommendation systems, on the other hand, aim to alleviate some of the challenges posed by traditional search engines by offering personalized content suggestions. These systems leverage various algorithms, including collaborative filtering and content-based filtering, to recommend items such as products, movies, or articles based on user preferences and behavior. While recommendation systems have proven effective for content discovery, they are often limited to specific domains and do not fully support complex, multi-turn interactions or conversational contexts.

Conversational AI systems, which incorporate natural language understanding and generation capabilities, have emerged to bridge the gap between keyword-based search and personalized recommendations. These systems allow users to engage in natural language conversations, providing a more intuitive and user-friendly way to interact with information and services. Conversational AI has found applications in various domains, including virtual assistants, customer support chatbots, and interactive content generation.

Despite these advancements, several challenges and limitations persist in the current state of the art. First, conversational AI systems often rely on conventional search engines to retrieve information or recommendations, limiting their ability to provide real-time, context-aware responses. Second, existing conversational systems may struggle to understand user intents accurately, especially in complex and evolving conversations. Third, while recommendation systems excel in suggesting items, they may not adequately integrate into conversational contexts or provide explanations for their recommendations.

In light of these limitations, there exists a need for an innovative approach that seamlessly combines the benefits of conversational interfaces, personalized recommendations, and real-time information retrieval. Such an approach should enable users to engage in dynamic, context-aware conversations with AI systems, receive personalized recommendations, and access relevant content efficiently. The invention presented herein addresses these challenges and offers a novel solution to enhance the user experience in conversational platforms.

In one embodiment, the system receives, through a conversational interface within a platform presented at a client device, one or more input submissions from a user engaging in a conversation with a generative AI system; generates, by the generative AI system and based on the conversation and the input submissions, a search query for a search engine backend of the platform; sends the search query to the search engine backend of the platform to retrieve at least a subset of a prompt as input to the generative AI system, the subset of the prompt including a sorted list of search results from the search engine backend and a set of annotations associated with the search results; processes the prompt to generate a set of personalized recommendations for the user based on at least the sorted list of search results, the set of annotations, the conversational context, and the user preferences; and presents, within the platform presented at the client device, the set of personalized recommendations for the user, the presentation incorporating media content representing at least a portion of the search result items.

Further areas of applicability of the present disclosure will become apparent from the remainder of the detailed description, the claims, and the drawings. The detailed description and specific examples are intended for illustration only and are not intended to limit the scope of the disclosure.

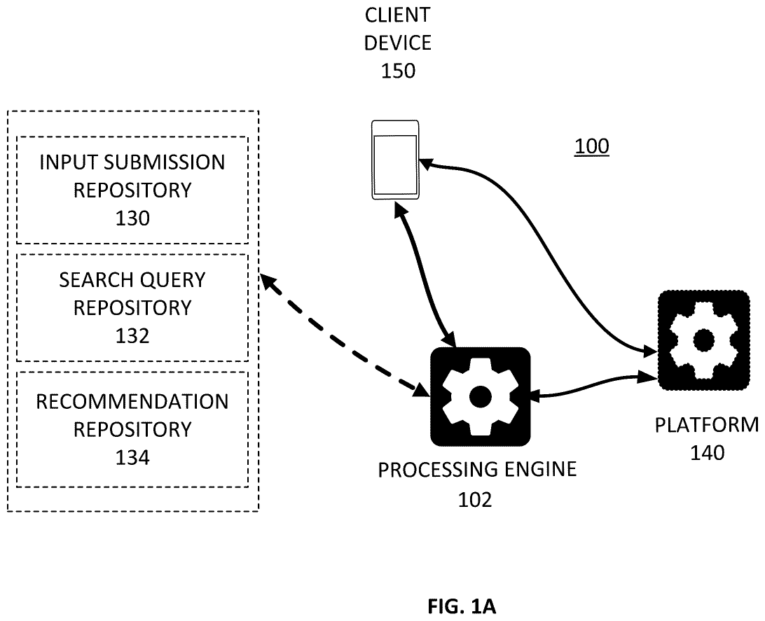

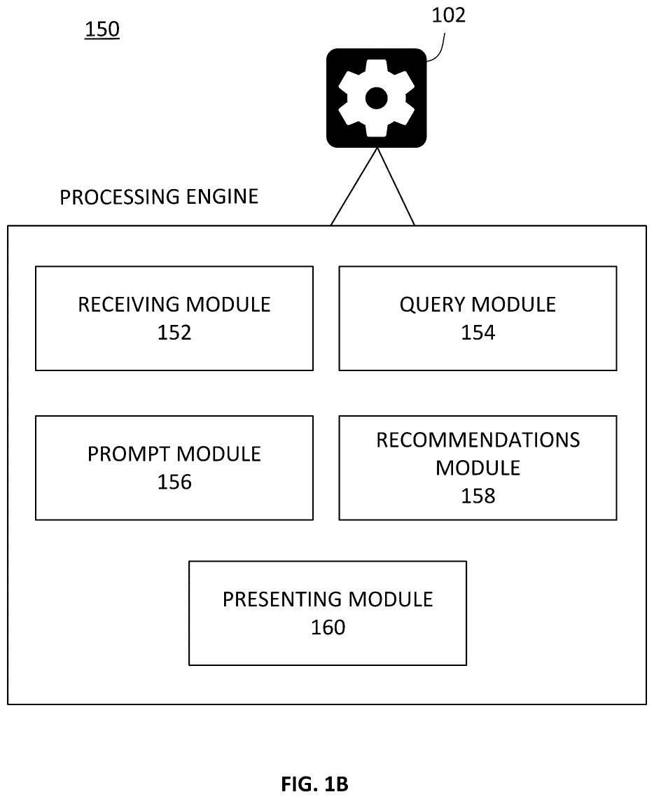

FIG. 1A is a diagram illustrating an exemplary environment in which some embodiments may operate. In the exemplary environment 100, a client device 150, and a platform 140 are connected to a processing engine 102. The processing engine 102 is optionally connected to one or more repositories and/or databases. Such repositories and/or databases may include, for example, an input submission repository 130, a search query repository 132, and a recommendation repository 134. One or more of such repositories may be combined or split into multiple repositories. The client device 150 in this environment may be a computer, and the platform 140 and processing engine 102 may be, in whole or in part, applications or software hosted on a computer or multiple computers which are communicatively coupled via remote server or locally.

The exemplary environment 100 is illustrated with only one client device, one processing engine, and one platform, though in practice there may be more or fewer additional client devices, processing engines, and/or platforms. In some embodiments, the client device, processing engine, and/or platform may be part of the same computer or device.

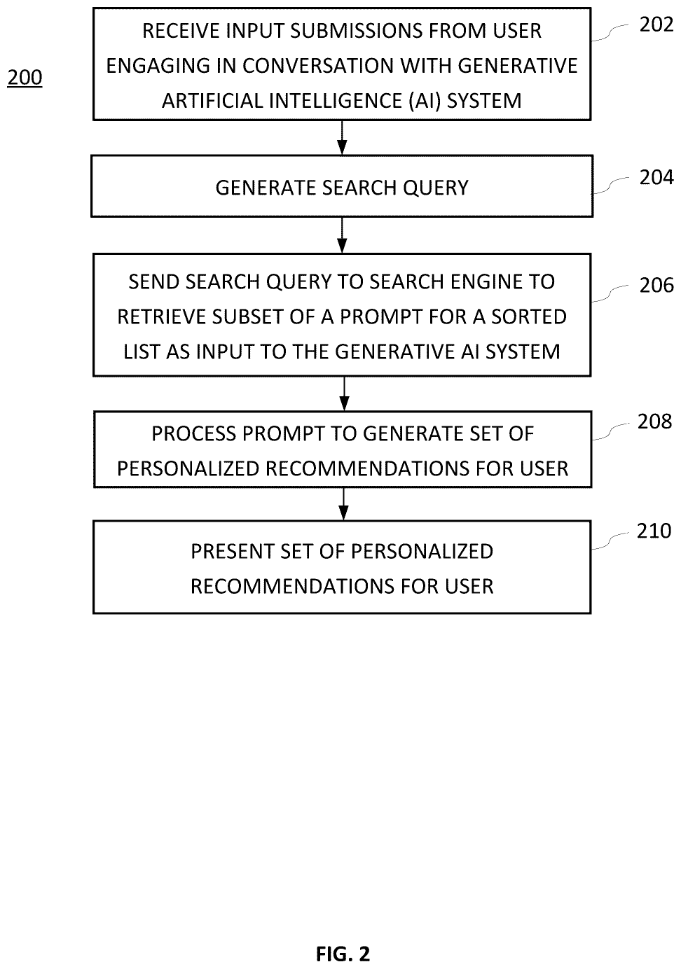

In an embodiment, the processing engine 102 may perform the method 200 (FIG. 2) or other method herein and, as a result, provide for dynamically optimized recommendations in generative media. In some embodiments, this may be accomplished via communication with the client device, additional client device(s), processing engine 102, platform 140, and/or other device(s) over a network between the device(s) and an application server or some other network server. In some embodiments, one or both of the processing engine 102 and platform 140 may be an application, browser extension, or other piece of software hosted on a computer or similar device, or in itself a computer or similar device configured to host an application, browser extension, or other piece of software to perform some of the methods and embodiments herein.

In some embodiments, the processing engine 102 performs processing tasks partially or entirely on the client device 102 in a manner that is local to the device and relies on the device's local processor and capabilities. In some embodiments, the processing engine 102 may perform processing tasks in a manner such that some specific processing tasks are performed locally, such as, e.g., visual AI processing tasks, while other processing tasks are performed remotely via one or more connected servers. In yet other embodiments, the processing engine 102 may processing tasks entirely remotely.

In some embodiments, client device 150 may be a device with a display configured to present information to a user of the device. In some embodiments, the client device 150 presents information in the form of a user interface (UI) with UI elements or components. In some embodiments, the client device 150 sends and receives signals and/or information to the processing engine 102 pertaining to the platform. In some embodiments, client device 150 is a computer device capable of hosting and executing one or more applications or other programs capable of sending and/or receiving information. In some embodiments, the client device 150 may be a computer desktop or laptop, mobile phone, virtual assistant, virtual reality or augmented reality device, wearable, or any other suitable device capable of sending and receiving information. In some embodiments, the processing engine 102 and/or platform 140 may be hosted in whole or in part as an application or web service executed on the client device 150. In some embodiments, one or more of the platform 140, processing engine 102, and client device 150 may be the same device. In some embodiments, the platform 140 and/or the client device 150 are associated with one or more particular user accounts.

In some embodiments, optional repositories function to store and/or maintain, respectively, input submissions from a user during a conversation within a generative AI system, search queries associated with the user's conversation, and recommendations generated for the user based on the results of search queries. The optional repositories may also store and/or maintain any other suitable information for the processing engine 102 to perform elements of the methods and systems herein pertaining to the platform. In some embodiments, the optional database(s) can be queried by one or more components of system 100 (e.g., by the processing engine 102), and specific stored data in the database(s) can be retrieved.

The platform is a platform configured to provide dynamically optimized recommendations in generative media to a user of the platform. In some embodiments, the platform may be hosted within an application that can be executed on the user's client device, such as a smartphone application.

FIG. 1B is a diagram illustrating an exemplary computer system 150 with software modules that may execute some of the functionality described herein. In some embodiments, the modules illustrated are components of the processing engine 102.

Receiving module 152 functions to receive, through a conversational interface within a platform presented at a client device, one or more input submissions from a user engaging in a conversation with a generative AI system.

Query module 154 functions to generate, by the generative AI system and based on the conversation and the input submissions, a search query for a search engine backend of the platform.

Prompt module 156 functions to send the search query to the search engine backend of the platform to retrieve at least a subset of a prompt as input to the generative AI system, the subset of the prompt including a sorted list of search results from the search engine backend and a set of annotations associated with the search results.

Recommendations module 158 functions to process the prompt to generate a set of personalized recommendations for the user based on at least the sorted list of search results, the set of annotations, the conversational context, and the user preferences.

Presenting module 160 functions to present, within the platform presented at the client device, the set of personalized recommendations for the user, the presentation incorporating media content representing at least a portion of the search result items.

The functionality of the above modules will be described in further detail with respect to the exemplary method of FIG. 2A below.

FIG. 2 is a flow chart illustrating an exemplary method that may be performed in some embodiments.

At step 202, the system receives, through a conversational interface within a platform presented at a client device, one or more input submissions from a user engaging in a conversation with a generative AI system. In some embodiments, this interaction with the user of the platform occurs through a conversational interface within a platform, which is presented on a client device operated by or otherwise associated with the user. The term “conversational interface” as used herein refers to the user-friendly interface through which users can communicate with the generative AI system using natural language, either in text or voice form. The platform serves as the environment in which this interaction takes place, and it could be a website, a mobile app, or any other software interface that facilitates conversations. The generative AI system in this context refers to one or more AI-based models designed, at least in part, to generate natural and contextually relevant conversational replies and answers to the user.

In some embodiments, this generative AI system is powered by a Large Language Model (hereinafter “LLM”). An LLM is a type of artificial neural network that has been trained on vast amounts of text data to understand and generate human-like language responses. In some embodiments, when a user submits input through the conversational interface within the platform, this input submission serves as a prompt to the LLM-based generative AI system. The LLM processes this prompt by analyzing the conversational context, understanding the user's preferences, and leveraging its extensive language knowledge to craft a coherent and contextually fitting response. In various embodiments, it does so by employing a variety of natural language processing techniques, such as, e.g., language modeling, tokenization, and/or context awareness.

In some embodiments, the LLM-based generative AI acts as a virtual conversational partner that can engage in dialogue with users, understand their inquiries, and generate meaningful responses. It does not merely provide pre-programmed responses, but rather has the capacity to generate dynamic and personalized answers based on, e.g., the unique conversational context and user preferences. This capability sets it apart from traditional rule-based systems, which lack the flexibility and adaptability to provide truly interactive and contextually rich conversations. By harnessing the power of LLMs, the generative AI system enhances the conversational experience within the platform, making interactions more natural, informative, and tailored to the individual user's needs.

In various embodiments, the input submissions provided by the user can encompass various forms of user-generated content, including, e.g., text messages, voice recordings, or any other input methods supported by the conversational interface. In some embodiments, these input submissions carry the conversational context, which includes the ongoing dialogue between the user and the generative AI system. This context is essential for the generative AI system to understand the user's current needs, preferences, and objectives.

In some embodiments, these input submissions provide information on the user's preferences, which can play a significant role in shaping the recommendations and responses generated by the AI system. In various embodiments, these preferences could range from specific requirements, such as, for example, pet-friendly accommodations in a travel context, to more general preferences, such as a preference for budget-friendly options or a preference for nearby locations. These user preferences are vital for tailoring the AI's recommendations to align with the user's individual tastes and needs. By incorporating the conversational context and user preferences, the generative AI system gains valuable insights into the user's objectives, enabling it to craft personalized recommendations and responses that enhance the user's experience within the platform.

In some embodiments, the system receives one or more pieces of contextual information from the conversation, which adds a layer of adaptability and responsiveness to the responses generated by the generative AI system. In various embodiments, this contextual information can include, for example, details such as the time of day, the geographic location of the user, and/or details on the specific niches, interests, or qualifications the user would like the system to consider. Incorporating this contextual information ensures that the generated content is not only user-specific, but also contextually relevant, increasing the likelihood of capturing the user's interest.

At step 204, the system generates, by the generative AI system and based on the conversation and the input submissions, a search query for a search engine backend of the platform. Following the receipt of user input submissions during the ongoing conversation, the generative AI system plays a pivotal role in the next step of the process. It leverages its understanding of the conversation's context and the user's preferences to dynamically generate a search query. In some embodiments, this search query is specifically crafted to interface with the search engine backend of the platform seamlessly. In some embodiments, generative AI system adjusts the formulation of the search query based on the conversational context, user preferences, and historical interactions.

In some embodiments, the generative AI system analyzes the conversation history with the user, extracting relevant keywords, phrases, and context cues. In some embodiments, the generative AI system analyzes the history of the current conversation session, while in other embodiments, it may additionally analyze the history of previous conversation sessions with the user. In some embodiments, the system takes into account the user's expressed preferences, ensuring that the search query aligns with the user's intent and needs. This process considers e.g., the conversational context, user-specific nuances, and the unique conversational flow.

Once the search query is generated, it is transmitted to the search engine backend of the platform. In some embodiments, this query acts as a tailored request, instructing the backend to retrieve a subset of search results that are most pertinent to the ongoing conversation and the user's preferences. By creating these custom search queries, the generative AI system enhances the platform's ability to provide highly personalized and contextually relevant search results, going beyond the limitations of conventional search engines that primarily rely on isolated keywords.

In some embodiments, the generative AI system is an LLM, which uses LLM-based techniques to generate a search query that is finely tuned to the user's conversational context and preferences. This process can make use of the LLM's natural language understanding and generation capabilities, allowing it to adapt and refine the search query for maximum relevance. In some embodiments, the LLM functions as a trained model capable of comprehending natural language inputs and generating human-like responses. In the conversation leading up to this step, it has already processed and replied to the input submissions from the user, thus accruing a comprehensive understanding of the user's preferences, conversational context, and intent from the conversation. This knowledge forms the basis by which the LLM builds the search query.

In various embodiments, to create the search query, the LLM employs a multi-faceted approach. In some embodiments, the LLM extracts keywords and phrases from the conversation that are indicative of the user's information needs. This contextual analysis extends beyond mere keyword extraction; the LLM is attuned to nuances in language, tone, and user-specific expressions, enabling it to generate search queries that closely align with the user's intent. In some embodiments, moreover, the LLM's generative capabilities allow it to construct a search query that is more than just a set of keywords. It crafts a coherent and context-aware query that encapsulates the user's preferences. For example, if a user has expressed an interest in “affordable hotels near the beach,” the LLM can create a search query that includes these specific criteria and possibly even additional context, such as location and date preferences.

In essence, the generative AI system, which may be embodied by an LLM in some embodiments, empowers this method with a remarkable capacity to bridge the conversational gap between the user and the platform's search engine backend. By leveraging its natural language understanding and generation abilities, it transforms the user's conversational context and preferences into search queries that yield highly personalized and contextually relevant search results.

At step 206, the system sends the search query to the search engine backend of the platform to retrieve at least a subset of a prompt as input to the generative AI system, the subset of the prompt including a sorted list of search results from the search engine backend and a set of annotations associated with the search results. In this step, the search query, which was generated by the generative AI system based on the user's conversational context and preferences, is transmitted to the search engine backend of the platform. This interaction marks the transition from the user-driven conversational phase to the backend data retrieval and processing phase of the method.

In some embodiments, when the system sends the search query, it instructs the platform's search engine backend to commence its search across its database of available content. The objective is to retrieve a subset of a prompt, which serves as input for the generative AI system. This prompt consists of two primary components: a sorted list of search results and a set of annotations intricately associated with each search result item.

In some embodiments, the prompt is meticulously composed to serve as input for a Large Language Model (LLM). In some embodiments, the prompt is composed as such to include details, in a prompt format understandable by the LLM, about the sorted list of search results, as well as the annotations pertaining to those results. In some embodiments, the prompt may itself be generated by a generative AI system, such as an LLM.

In some embodiments, the sorted list of search results represents the outcome of the search engine backend's query execution. In various embodiments, these search results are not presented in random order, but rather are sorted according to a set of criteria that typically include, for example, relevance, user preferences, historical interactions, and various other contextual factors. This sorting ensures that the most pertinent and valuable search results are prominently positioned at the top of the list, thereby enhancing the user's search experience.

In some embodiments, accompanying these search results are annotations that provide valuable context and information pertaining to each search result item. In some embodiments, these annotations are akin to metadata, encapsulating one or more pieces of information that elucidate the nature and relevance of the search result. In various embodiments, they might include details such as, e.g., pricing, availability, user ratings, geographic location, and any other pertinent attributes. Annotations, therefore, serve as a critical bridge between the raw search results and the user, offering a concise and informative summary of each item.

In some embodiments, the generative AI system is primed to digest both the sorted list of search results and their accompanying annotations within the prompt. This ensures that the AI system is equipped with a comprehensive understanding of the available options and the context in which they are presented. Armed with this information, the generative AI system is well-prepared to carry out the subsequent step of processing the prompt to generate a set of personalized recommendations tailored precisely to the user's needs and preferences.

This step of sending the search query and receiving the prompt signifies a seamless handover between the user's conversational interaction and the platform's backend data processing, culminating in a prompt that forms the foundation for the AI-driven recommendation process.

At step 208, the system processes the prompt to generate a set of personalized recommendations for the user based on at least the sorted list of search results, the set of annotations, the conversational context, and the user preferences.

In some embodiments, the AI system generates a set of personalized recommendations tailored explicitly to the user. In some embodiments, this processing may involve making use of one or more inputs, including, e.g., the sorted list of search results, the accompanying annotations, the ongoing conversational context, and the user's expressed preferences.

In some embodiments, the generative AI system leverages the sorted list of search results to understand the landscape of available options comprehensively. It considers not only the inherent ranking of these results, but also the inherent features and attributes associated with each. Through this process, the AI system understands the most pertinent choices among the list, ensuring that the subsequent recommendations are intrinsically connected to the user's underlying search query and preferences.

In some embodiments, moreover, the set of annotations attached to each search result is used as an input to the system. In various embodiments, the generative AI system dissects these annotations, extracting details such as, e.g., pricing, availability, ratings, and any other relevant metadata. These annotations serve as a vital bridge between raw data and user-friendly recommendations, enabling the AI system to provide context-rich suggestions that facilitate the user's decision-making process.

In some embodiments, the ongoing conversational context plays a role in refining these recommendations. In some embodiments, the generative AI system takes into account the user's previous conversational inputs, recognizing, e.g., nuances, preferences, and any evolving elements in the dialogue. This contextual awareness allows the AI system to make recommendations that align not only with the immediate query but also with the broader narrative of the conversation.

In some embodiments, the user's explicit preferences are incorporated into the recommendation generation process. The generative AI system gives paramount importance to the user's stated desires, ensuring that the resulting recommendations are in harmony with their individual tastes and requirements.

In some embodiments, the generative AI system considers the metadata associated with the search results to fine-tune the generation of personalized recommendations. Metadata, in the context of search results, refers to additional information or attributes associated with each search result item. In various embodiments, these attributes can include various details like product descriptions, user ratings, availability, price, and more.

In some embodiments, the generative AI system takes into account this metadata to fine-tune the process of generating personalized recommendations. As part of the search process, the platform's search engine backend provides not only the search results but also the metadata associated with each result. This metadata serves as valuable context and information about the items in the search results. The generative AI system analyzes this metadata alongside the sorted list of search results and annotations. In various embodiments, it considers attributes such as, e.g., product ratings, user reviews, pricing information, and availability status, among others. By factoring in this metadata, the generative AI system gains a deeper understanding of the individual search result items. It can use this information to better match user preferences and the conversational context with the most relevant items. In some embodiments, the fine-tuning process involves adjusting the recommendations based on the specific attributes and details found in the metadata. For example, if a user has shown a preference for highly-rated products, the generative AI can prioritize items with favorable ratings when generating recommendations.

In some embodiments, the generative AI system assigns a priority score to each recommendation based on a combination of search result rankings, annotations, and user preferences. These scores determine the order in which personalized recommendations are presented to the user. In some embodiments, the system considers the rankings assigned by the search engine backend to the initial list of search results. These rankings reflect the platform's assessment of the relevance and value of each search result. In some embodiments, the system considers the annotations, which may contain additional information such as, e.g., user ratings, pricing, availability, and other relevant details. In some embodiments, the system takes into account the user's preferences, gathered during the ongoing conversation. In various embodiments, these can be explicit choices or implied preferences based on previous interactions. In some embodiments, the generative AI combines these elements using a defined algorithm or scoring system to assign a priority score to each recommendation. These scores determine the order of presentation, with higher scores indicating greater relevance to the user's preferences and context.

In various embodiments, the media content integrated into the presentation of personalized recommendations includes images, audio clips, video snippets, or a combination thereof. The recommendations may feature images that provide visual representations of the suggested items. These images can help users quickly assess the appearance and attributes of the recommended products or services. In some embodiments, audio clips may be integrated into the recommendations. This could be particularly useful for products or services where audio content is relevant, such as, e.g., music, podcasts, or language courses. Users might be able to sample audio content to make informed decisions. In some embodiments, video clips may offer dynamic previews of the recommended items.

At step 210, the system presents, within the platform presented at the client device, the set of personalized recommendations for the user, the presentation incorporating media content representing at least a portion of the search result items. In various embodiments, this presentation is not merely a static list of suggestions, but instead an immersive and engaging experience designed to enhance the user's interaction within the platform. In some embodiments, it occurs seamlessly within the platform, precisely where the user is engaged, on their client device. In various embodiments, the presentation occurs in real time or substantially real time during or after the user's conversation on the platform.

In some embodiments, central to this presentation is the incorporation of media content, which adds depth and richness to the recommendations. Rather than providing merely a textual list, the generative AI system can leverage various forms of media, such as, for example, text, images, audio clips, video snippets, interactive elements, or a combination thereof, to represent at least a portion of the search result items. This multimedia approach transforms the recommendations into visually appealing and informative content that captures the user's attention.

For example, if the search query was related to vacation rentals, the presentation may include high-resolution images of the suggested properties, showcasing their aesthetics and features. Additionally, it could include short video clips that offer virtual tours, giving the user a real sense of what to expect. This multimedia integration not only makes the recommendations more enticing but also aids in the user's decision-making process.

In some embodiments, the presentation is seamlessly integrated within the platform's user interface, ensuring a cohesive and user-friendly experience. In some embodiments, users do not need to navigate to separate pages or interfaces to view the recommendations; instead, they are presented within the existing context of their interaction.

In some embodiments, furthermore, the generative AI system ensures that the presentation aligns with the user's device and preferences. Whether the user is accessing the platform through a smartphone, tablet, or desktop computer, the recommendations are optimized for the specific screen size and capabilities. This adaptability ensures that the presentation remains visually appealing and functional across various devices.

In some embodiments, the generative AI system is further configured to continue the conversation with the user to determine a refinement of the user preferences. After the user has provided input submissions and engaged in a conversation, the generative AI system continues to actively communicate with the user. This ongoing conversation serves the purpose of delving deeper into the user's preferences and refining the recommendations to better align with the user's evolving needs and desires.

In some embodiments, as the conversation progresses, the generative AI system may inquire about specific details or seek clarification on certain preferences. For example, if a user is searching for a vacation rental and initially expresses interest in properties near the beach, the AI might follow up with questions like, “Are you looking for a private beachfront property or something within walking distance to the beach?” By engaging the user in this manner, the AI can gather more specific and nuanced information.

Furthermore, in some embodiments, the generative AI system may provide the user with additional options or suggestions based on the ongoing conversation. It can offer alternatives that the user might not have initially considered or inquire about other factors that could influence their decision. This iterative process ensures that the recommendations presented to the user are continuously refined and personalized to an increasingly granular level.

In some embodiments, the generative AI system is further configured to iteratively generate an updated search query and present refined personalized recommendations based on ongoing conversation with the user. In some embodiments, unlike a one-time recommendation generation, the generative AI system remains actively engaged with the user, tracking the conversation's progression. As the user provides more information or refines their preferences, the AI system leverages this new context to generate updated search queries that are more finely tuned to the user's current needs. For example, if a user initially expresses interest in beachfront vacation rentals but later mentions a preference for properties with specific amenities like a private pool, the generative AI system can iteratively modify the search query to incorporate these refined criteria. In some embodiments, it may also adjust the weighting of different factors in the recommendations, prioritizing properties that align more closely with the user's latest input.

In some embodiments, the system detects whether one or more paid promotions have materially affected the sorting or content of the presented recommendations, and then presents a disclosure of the paid promotions that materially affected the sorting or content of the presented recommendations. In some use cases, paid promotions can significantly influence the sorting and content of recommendations. Thus, the system can be configured for the detection and disclosure of such paid promotions to ensure users are aware of any external influences on their recommendations. In some embodiments, the system detects whether one or more paid promotions have had a substantial impact on the sorting or content of the recommendations. In some embodiments, this detection process involves analyzing the search results and annotations, as well as monitoring any external factors, such as sponsored listings or paid advertising, that might have influenced the recommendations.

In some embodiments, once detected, the system assesses whether these paid promotions have materially affected the recommendations. Material impact implies that the recommendations would have been substantially different without these paid promotions. This assessment helps to identify cases where external interests significantly sway the user experience.

In some embodiments, if the system determines that paid promotions have indeed had a material impact on the recommendations, it initiates a disclosure process. This disclosure is presented to the user, making them aware of the external influence on their personalized recommendations. It may include clear indications, labels, or explanations about which recommendations were influenced by paid promotions.

In some embodiments, the generative AI system adjusts the sorting order of search results based on the user preferences and context to ensure the most relevant recommendations are prominently displayed. In some embodiments, this adjustment is executed with consideration of both user preferences and the ongoing context of the conversation. The primary objective is to prominently showcase the most pertinent recommendations for the user. In some embodiments, the generative AI system takes into account the user's stated preferences. For instance, if a user has expressed a preference for pet-friendly accommodations in a vacation rental search, the AI will prioritize and prominently display listings that align with this preference. This ensures that the user is presented with options that are most relevant to their specific requirements or desires.

In some embodiments, the generative AI system also maintains awareness of the conversation's context. This means that as the conversation evolves and the user provides more information or refines their criteria, the AI adapts the sorting order of search results accordingly. For example, if a user initially requested vacation rentals near the beach but later mentioned a preference for a more secluded location, the AI might re-sort the results to prioritize listings that meet this updated criteria.

In some embodiments, by adjusting the sorting order based on user preferences and contextual information, the generative AI system enhances the user's experience by ensuring that the most relevant and suitable recommendations are prominently displayed. This not only saves the user time but also increases the likelihood of them finding options that align with their needs and preferences.

In some embodiments, the platform tracks user interactions and responses to the presented recommendations to improve the accuracy of future recommendations. In some embodiments, the system actively records how users engage with the recommendations, such as tracking, e.g., clicks, views, selections, and/or other relevant actions. In some embodiments, it additionally tracks how users respond to these recommendations, including whether their responses are positive or negative and the specific actions they take, such as making purchases or providing feedback. In some embodiments, by employing machine learning and data-driven techniques, the system adapts its recommendation strategies based on user feedback and behavioral data. Over time, it becomes proficient at tailoring recommendations to individual users, ensuring that future recommendations align with users' evolving preferences.

In some embodiments, the generative AI system employs machine learning techniques to refine the personalized recommendations based on user interactions and feedback. In some embodiments, the generative AI system leverages machine learning algorithms and models to analyze user interactions and feedback systematically. These algorithms are designed to detect patterns, preferences, and trends in how users engage with the personalized recommendations. In some embodiments, the AI system monitors how users interact with the recommendations it presents. In various embodiments, it tracks user actions such as, e.g., clicks, views, purchases, and/or any other relevant engagement metrics. By analyzing these interactions, the system gains valuable insights into which recommendations are most effective and appreciated by users. In some embodiments, user feedback plays a pivotal role in the refinement process. In various embodiments, the generative AI system can take into account explicit feedback provided by users, such as, e.g., ratings, reviews, or comments. Additionally, it may analyze implicit feedback, such as, e.g., dwell time on recommended items or revisiting specific suggestions.

In some embodiments, as the AI system accumulates data from various users and their interactions, it adapts and refines its recommendation algorithms. This adaptive learning process allows the system to continuously improve its ability to suggest content that aligns with individual user preferences and needs. In some embodiments, by employing machine learning techniques and actively learning from user interactions and feedback, the generative AI system aims to deliver increasingly accurate, relevant, and personalized recommendations. This iterative refinement process ensures that users are presented with content that genuinely resonates with their interests and requirements.

In some embodiments, the personalized recommendations presented to the user are influenced by the user's geographic location and other contextual factors. In some embodiments, the generative AI system takes into account the user's current geographic location as a key contextual factor. It may consider factors such as, for example, the user's city, region, or even precise coordinates when generating recommendations. For example, if a user is in a specific city, the system may suggest nearby restaurants, events, or services that are relevant to that location. In some embodiments, based on the user's geographic location, the system can recommend content that is geographically relevant. In various embodiments, this may include suggestions for, e.g., local businesses, tourist attractions, or events happening in the vicinity of the user. By factoring in location, the recommendations become more pertinent to the user's immediate surroundings.

In some embodiments, the system's ability to adapt to the user's location can be dynamic. For example, if the user is traveling and their location changes, the recommendations can adjust accordingly to provide relevant suggestions based on the new geographic context. Other factors could encompass, for example, the time of day, weather conditions, user preferences, and historical interactions.

In some embodiments, the generative AI system can prompt the user for additional information to further tailor the search query and recommendations. This feature serves the purpose of further refining the search query and, subsequently, the recommendations provided to the user. In some embodiments, the system actively engages the user in a conversation or interaction. During this process, it may identify certain aspects of the user's preferences, needs, or context that require clarification or elaboration. In some embodiments, in response to identified areas of ambiguity or to gather more specific information, the generative AI system prompts the user with queries or requests for additional details. These prompts aim to enhance the accuracy and relevance of the recommendations. The additional information obtained from the user through these prompts is used to refine the search query. This refined query is then submitted to the search engine backend to retrieve more precise search results. In some embodiments, as a result of this iterative process, the recommendations generated by the system become increasingly tailored to the user's requirements and preferences. In various embodiments, the prompts can take various forms, such as, for example, questions seeking clarification, multiple-choice options, or open-ended inquiries. The specific format of the prompts may vary depending on the nature of the conversation and the information needed.

In some embodiments, the generative AI system adapts its recommendation generation process based on the user's feedback and preferences over time. In some embodiments, as users interact with the system and provide feedback on the recommendations they receive, the generative AI system carefully analyzes this feedback. It takes into account user ratings, reviews, explicit preferences, and implicit behaviors to discern patterns and trends. By understanding how users respond to different recommendations and identifying their evolving preferences, the system becomes more adept at tailoring future recommendations to individual users.

In various embodiments, this adaptation process involves the adjustment of various recommendation parameters, including the weighting of different factors that influence the recommendation process. For instance, the system may assign varying levels of importance to factors such as, e.g., search result rankings, annotations, and user preferences based on the observed impact of these factors on user satisfaction and engagement.

In some embodiments, the generative AI system incorporates user-provided ratings or feedback on recommended items to enhance subsequent recommendations. When users interact with the system and provide feedback, such as ratings or comments, regarding the recommendations they receive, this feedback becomes a valuable resource for refining the recommendation process. In some embodiments, the system takes into account the specific feedback received for recommended items, whether it's a user giving a high rating to a product, expressing satisfaction with a recommendation, or providing comments on why a recommendation was or wasn't suitable. This feedback is analyzed and utilized to fine-tune the recommendation generation process.

In some embodiments, by considering user-provided ratings and feedback, the generative AI system identifies patterns and trends in user preferences and satisfaction. It learns which types of recommendations are well-received and which may require improvement. This learning process enables the system to adapt its recommendation algorithms, adjusting factors like item weighting, recommendation ranking, and content selection.

In some embodiments, the system adjusts the presentation format of the personalized recommendations based on the user's device and preferences, including devices with different screen sizes and capabilities. When a user interacts with the platform using a particular device, such as a smartphone, tablet, laptop, or desktop computer, the system assesses the device's attributes. In various embodiments, this assessment includes factors such as, e.g., screen size, resolution, and compatibility with different media formats (e.g., images, videos, or text). In some embodiments, based on the device's characteristics and the user's defined preferences, the system dynamically adjusts how the personalized recommendations are presented. For example, recommendations may be optimized for smaller screens by prioritizing concise text descriptions or adapting images and videos for better visibility. On larger screens, the system may take advantage of additional space to provide more detailed content or larger images. Moreover, in some embodiments, the user's personal preferences regarding the presentation style, such as, e.g., grid view, list view, or slideshow, are also taken into account. This ensures that the presentation format aligns with the user's preferences, creating a more tailored and user-friendly experience.

In some embodiments, the generative AI system is further configured to continue the conversation with the user to determine a refinement of the user preferences. In some embodiments, as the user interacts with the platform and receives recommendations, the generative AI system actively collects feedback and input from the user. The generative AI system uses this ongoing conversation to ask the user clarifying questions, seek additional information, or confirm specific details related to their preferences. For example, if a user initially expressed interest in “beachfront vacation rentals,” the system might engage in a conversation to inquire about the desired location, budget, preferred amenities, or specific dates for the trip. Through this iterative process, the generative AI system progressively hones in on the user's precise preferences, gaining a deeper understanding of their needs and preferences with each interaction. It adapts its recommendations accordingly, ensuring that the presented options become increasingly relevant and aligned with the user's evolving tastes.

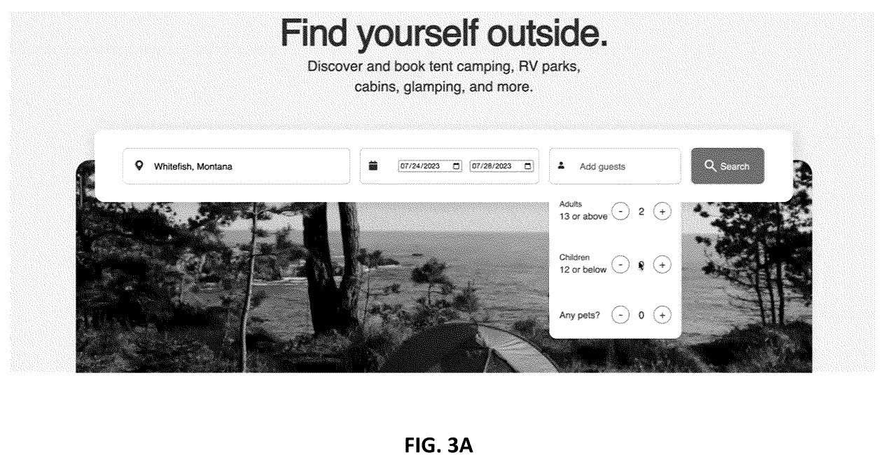

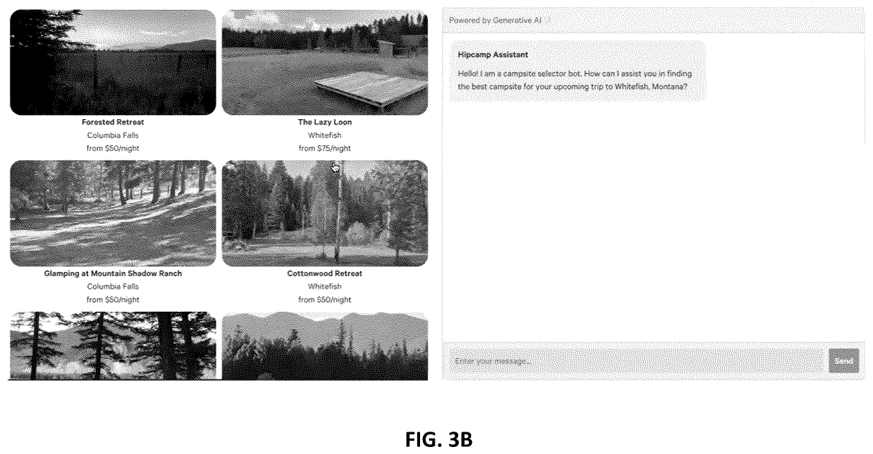

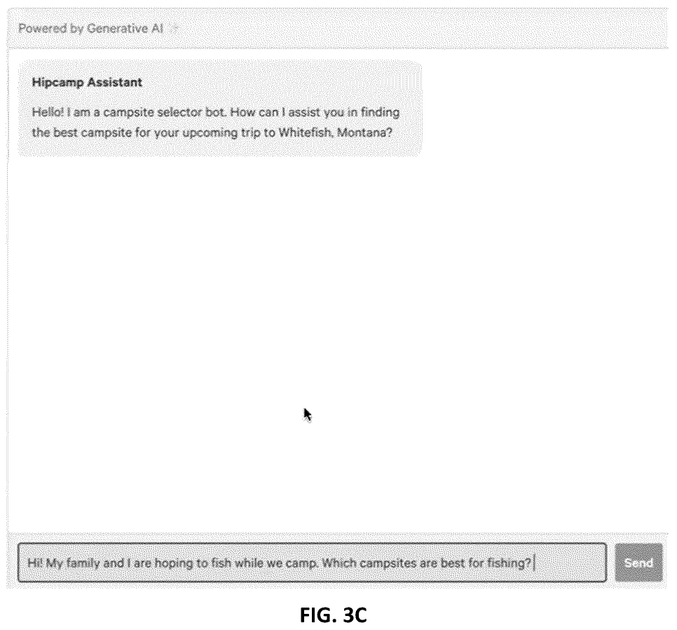

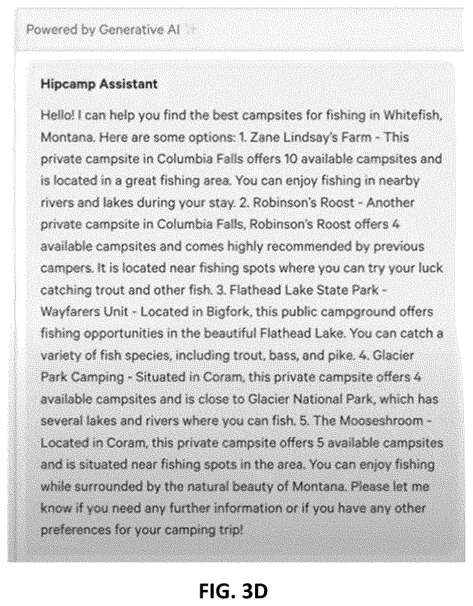

FIG. 3A is a diagram illustrating one example embodiment of a user interface screenshot which presents one use case for facilitating recommendations for outdoor accommodation discovery and booking, in accordance with some embodiments. At the top of the screenshot, prominent text reads, “Find yourself outside. Discover and book tent camping, RV parks, cabins, glamping, and more.” Below this introductory text, the user interface prominently features a text field where users can specify their desired location. In the provided example, the user has entered “Whitefish, Montana” into this field, indicating an intent to find outdoor accommodations in that specific destination. Additional fields enable users to specify their intended dates of arrival and departure. The user has also selected the number of adults needing accommodations, in this case, 2 adults.

Lastly, positioned to the right of these input fields, a prominent “Search” button is displayed. This button serves as the user's trigger to initiate the search based on their specified criteria. The user can simply click this button when they have inputted all the necessary details.

FIG. 3B is a diagram illustrating one example embodiment of a user interface screenshot which presents search results and a conversational user interface with a generative AI chatbot, in accordance with some embodiments. This example presents the next stage within the platform's interface after the user clicks on the “Search” button from FIG. 3A. The screenshot reveals a split-screen layout, with the left side showcasing initial search results for outdoor accommodations in Whitefish, Montana, based on the user's specified criteria.

To the right of these search results, the interface seamlessly transitions into a conversational user interface. In this context, the platform introduces a helpful assistant chatbot to assist the user further in their search. The chatbot's first message, prominently displayed at the top of the chat interface, reads, “Hello! I am a campsite selector bot. How can I assist you in finding the best campsite for your upcoming trip to Whitefish, Montana?” Directly below the chatbot's introductory message, a text entry field is presented. This text field invites the user to engage in a conversation with the chatbot by typing in their questions, preferences, or requests. Users can easily enter text here to communicate their specific needs and receive personalized recommendations tailored to their preferences. To enable user interaction with the chatbot, a “Send” button is positioned to the right of the text entry field. This button allows users to transmit their messages to the chatbot, initiating a responsive and dynamic conversation.

FIG. 3C is a diagram illustrating one example embodiment of a user interface screenshot which presents a user interacting with a generative AI chatbot within a conversational interface, in accordance with some embodiments. The conversational interface within the platform's user interface continues the interaction between the user and the campsite selector bot. The user has actively engaged with the chatbot by typing a message into the text entry field. The user's message reads, “Hi! My family and I are hoping to fish while we camp. Which campsites are best for fishing?” This message conveys the user's specific intent and preferences, indicating a desire for campsite recommendations that are conducive to fishing activities.

The chatbot, as a responsive and helpful virtual assistant, is now poised to provide a tailored response based on the user's query. It will analyze the user's request, considering factors such as the location (Whitefish, Montana), the user's interests (fishing), the context of the visit (a family fishing trip), the precise details of accommodations desired (a campsite in close proximity to a fishing spot), and potentially other preferences or criteria that were collected during the initial interaction. The chatbot's response will thus include personalized campsite recommendations that align with the user's request for excellent fishing opportunities.

FIG. 3D is a diagram illustrating one example embodiment of a user interface screenshot which presents a response from a generative AI system to a user's personalized needs and requests within a conversational interface, in accordance with some embodiments. The conversational interface presents a detailed response from the campsite selector bot to the user's query regarding the best campsites for fishing in Whitefish, Montana. The response exemplifies the capabilities of the generative AI system to provide personalized and context-aware recommendations.

The chatbot begins its message with a friendly greeting, saying, “Hello! I can help you find the best campsites for fishing in Whitefish, Montana. Here are some options:” The generative AI system, at this point, has generated a set of recommendations based on the user's preferences and the information available. These recommendations are presented in a structured format, including a first recommendation of: “1. Zane Lindsay's Farm—This private campsite in Columbia Falls offers 10 available campsites and is located in a great fishing area. You can enjoy fishing in nearby rivers and lakes during your stay.” Each recommendation includes a campsite name, a brief description, and annotations explaining why it's a suitable choice for the user's specific needs. This information is generated in real-time by the generative AI, taking into account factors such as the campsite's location, available amenities, and proximity to fishing areas. These are taken into account from, e.g., the interactions with the user during the conversation, the conversational context, and more This example demonstrates how the system seamlessly integrates user interactions, conversational AI, and personalized recommendations, enhancing the user's experience by providing tailored information for their needs.

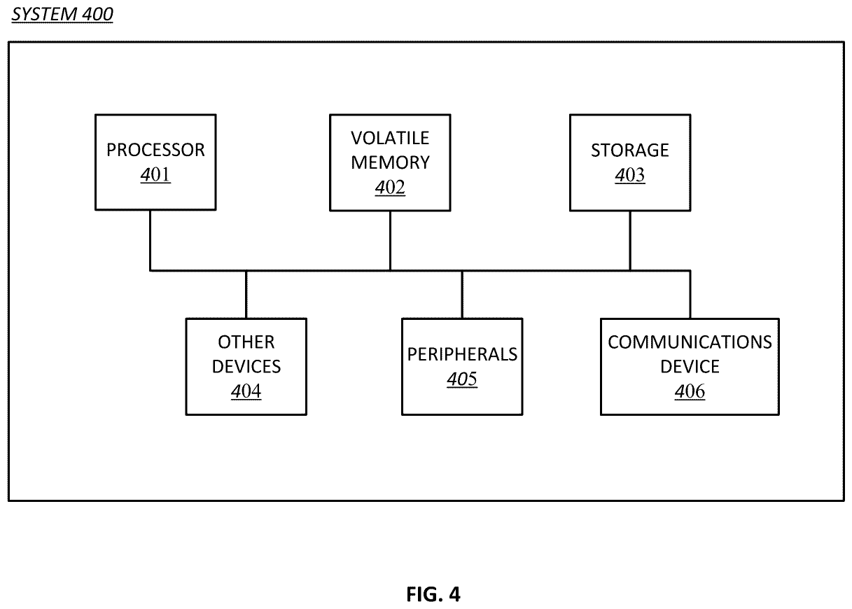

FIG. 4 is a diagram illustrating an exemplary computer that may perform processing in some embodiments. Exemplary computer 400 may perform operations consistent with some embodiments. The architecture of computer 400 is exemplary. Computers can be implemented in a variety of other ways. A wide variety of computers can be used in accordance with the embodiments herein.

Processor 401 may perform computing functions such as running computer programs. The volatile memory 402 may provide temporary storage of data for the processor 401. RAM is one kind of volatile memory. Volatile memory typically requires power to maintain its stored information. Storage 403 provides computer storage for data, instructions, and/or arbitrary information. Non-volatile memory, which can preserve data even when not powered and including disks and flash memory, is an example of storage. Storage 403 may be organized as a file system, database, or in other ways. Data, instructions, and information may be loaded from storage 403 into volatile memory 402 for processing by the processor 401.

The computer 400 may include peripherals 405. Peripherals 405 may include input peripherals such as a keyboard, mouse, trackball, video camera, microphone, and other input devices. Peripherals 405 may also include output devices such as a display. Peripherals 405 may include removable media devices such as CD-R and DVD-R recorders/players. Communications device 406 may connect the computer 100 to an external medium. For example, communications device 406 may take the form of a network adapter that provides communications to a network. A computer 400 may also include a variety of other devices 404. The various components of the computer 400 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method for providing personalized recommendations from a generative artificial intelligence (AI) system integrated within a platform, comprising:
receiving, through a conversational interface within a platform presented at a client device, one or more input submissions from a user engaging in a conversation with a generative AI system, the conversation comprising a conversational context, the input submissions comprising one or more user preferences;
generating, by the generative AI system and based on the conversation and the input submissions, a search query for a search engine backend of the platform;
sending the search query to the search engine backend of the platform to retrieve at least a subset of a prompt as input to the generative AI system, the subset of the prompt comprising a sorted list of search results from the search engine backend and a set of annotations associated with the search results, the annotations each comprising one or more pieces of information relating to one of the search result items;
processing, by the generative AI system, the prompt to generate a set of personalized recommendations for the user based on at least the sorted list of search results, the set of annotations, the conversational context, and the user preferences; and
presenting, within the platform presented at the client device, the set of personalized recommendations for the user, the presentation incorporating media content representing at least a portion of the search result items.

2. The method of claim 1, wherein the generative AI system is further configured to continue the conversation with the user to determine a refinement of the user preferences.

3. The method of claim 1, wherein the generative AI system is further configured to iteratively generate an updated search query and present refined personalized recommendations based on ongoing conversation with the user.

4. The method of claim 1, further comprising:
detecting whether one or more paid promotions have materially affected the sorting or content of the presented recommendations; and
presenting a disclosure of the paid promotions that materially affected the sorting or content of the presented recommendations.

5. The method of claim 1, wherein the generative AI system adjusts the formulation of the search query based on the conversational context, user preferences, and historical interactions.

6. The method of claim 1, wherein the generative AI system considers the metadata associated with the search results to fine-tune the generation of personalized recommendations.

7. The method of claim 1, wherein the generative AI system assigns a priority score to each recommendation based on a combination of search result rankings, annotations, and user preferences.

8. The method of claim 1, wherein the media content integrated into the presentation of personalized recommendations includes images, audio clips, video snippets, or a combination thereof.

9. The method of claim 1, wherein the generative AI system adjusts the sorting order of search results based on the user preferences and context to ensure the most relevant recommendations are prominently displayed.

10. The method of claim 1, wherein the generative AI system employs machine learning techniques to refine the personalized recommendations based on user interactions and feedback.

11. The method of claim 1, wherein the personalized recommendations presented to the user are influenced by the user's geographic location and other contextual factors.

12. The method of claim 1, wherein the generative AI system can prompt the user for additional information to further tailor the search query and recommendations.

13. A system for providing personalized recommendations from a generative artificial intelligence (AI) system integrated within a platform, comprising one or more processors configured to perform the operations of:
receiving, through a conversational interface within a platform presented at a client device, one or more input submissions from a user engaging in a conversation with a generative AI system, the conversation comprising a conversational context, the input submissions comprising one or more user preferences;
generating, by the generative AI system and based on the conversation and the input submissions, a search query for a search engine backend of the platform;
sending the search query to the search engine backend of the platform to retrieve at least a subset of a prompt as input to the generative AI system, the subset of the prompt comprising a sorted list of search results from the search engine backend and a set of annotations associated with the search results, the annotations each comprising one or more pieces of information relating to one of the search result items;
processing, by the generative AI system, the prompt to generate a set of personalized recommendations for the user based on at least the sorted list of search results, the set of annotations, the conversational context, and the user preferences; and
presenting, within the platform presented at the client device, the set of personalized recommendations for the user, the presentation incorporating media content representing at least a portion of the search result items.

14. The system of claim 13, wherein the generative AI system employs natural language processing techniques to understand and respond to the user's conversational input.

15. The system of claim 13, wherein the platform tracks user interactions and responses to the presented recommendations to improve the accuracy of future recommendations.

16. The system of claim 13, wherein the generative AI system adapts its recommendation generation process based on the user's feedback and preferences over time.

17. The system of claim 13, wherein the generative AI system incorporates user-provided ratings or feedback on recommended items to enhance subsequent recommendations.

18. The system of claim 13, wherein the one or more processors are further configured to perform the operation of:
adjusting the presentation format of the personalized recommendations based on the user's device and preferences, including devices with different screen sizes and capabilities.

19. The system of claim 13, wherein the generative AI system is further configured to continue the conversation with the user to determine a refinement of the user preferences.

20. A non-transitory computer-readable medium for providing personalized recommendations from a generative artificial intelligence (AI) system integrated within a platform, comprising:
instructions for receiving, through a conversational interface within a platform presented at a client device, one or more input submissions from a user engaging in a conversation with a generative AI system, the conversation comprising a conversational context, the input submissions comprising one or more user preferences;
instructions for generating, by the generative AI system and based on the conversation and the input submissions, a search query for a search engine backend of the platform;
instructions for sending the search query to the search engine backend of the platform to retrieve at least a subset of a prompt as input to the generative AI system, the subset of the prompt comprising a sorted list of search results from the search engine backend and a set of annotations associated with the search results, the annotations each comprising one or more pieces of information relating to one of the search result items;
instructions for processing, by the generative AI system, the prompt to generate a set of personalized recommendations for the user based on at least the sorted list of search results, the set of annotations, the conversational context, and the user preferences; and
instructions for presenting, within the platform presented at the client device, the set of personalized recommendations for the user, the presentation incorporating media content representing at least a portion of the search result items.
